(19) United States
(12) Patent Application Publication
(10) Pub. No.: US 2014/0032164 A1
(43) Pub. Date: Jan. 30, 2014

(54) IDENTIFYING AND LOCATING PLURAL SIGNAL EMITTERS

(71) Applicants: Andy LIAO, San Diego, CA (US); Jeremy Clifford Hsu, San Diego, CA (US); Daniel Scott Weinstein, San Diego, CA (US)

(72) Inventors: Andy LIAO, San Diego, CA (US); Jeremy Clifford Hsu, San Diego, CA (US); Daniel Scott Weinstein, San Diego, CA (US)

(21) Appl. No.: 13/559,394

(22) Filed: Jul. 26, 2012

(51) Int. Cl. G01C 15/00; G06F 15/00

(52) U.S. Cl. 702/150

(57) ABSTRACT

A system includes plural emitters each associated with a stylus or other entity. Each emitter is independently displaceable over an area, and emits an electromagnetic signal modulated in accordance with a distinct pattern. A single sensor is configured to detect the plural emitters. Associated signal processing determines the identity and location of each emitter. Corresponding data is communicated to a computer for traversed pathway determination, recording, writing or character recognition, or other operations.

### BACKGROUND

Handheld or otherwise displaceable signal emitters are used in various systems and applications. In one example, a handheld stylus or wand is used as a user input device for a computer or video gaming system. Movement, orientation or position of the input device is detected by the computer or gaming system and corresponding functions are performed accordingly.

However, such systems must use plural sensors in one-to-one association with the emitters to be sensed. That is, such systems do not accommodate the simultaneous operation of plural input devices by way of a single sensor, resulting in corresponding complexity and cost of implementation. The present teachings address the foregoing and related concerns.

### BRIEF DESCRIPTION OF THE DRAWINGS

The present embodiments will now be described, by way of example, with reference to the accompanying drawings, in which:

FIG. 1 depicts a schematic diagram of a system including plural signal emitters according to one example of the present teachings;

FIG. 2 depicts a diagram of another system in accordance with another example;

FIG. 3 depicts a signal timing diagram of respective modulation patterns according to another example;

FIG. 4 depicts a signal waveform according to an example;

FIG. 5 depicts a flow diagram of a method in accordance with another example of the present teachings.

### DETAILED DESCRIPTION

### Introduction

A system includes plural emitters, each associated with a stylus or other entity. Each emitter is independently displaceable over an area, and emits an electromagnetic signal modulated in accordance with a distinct pattern. A single sensor is configured to detect the plural emitters. Signal processing coupled to the sensor, or integrated therewith, determines the identity and location of each emitter. Corresponding data is communicated to a computer for traversed pathway determination, recording, writing or character recognition, or other operations.

In one example, a system includes a plurality of emitters, each configured to issue an electromagnetic signal characterized by a distinct modulation pattern. The system also includes a sensor configured to detect the electromagnetic signals. The system further includes a signal processor coupled to the sensor and configured to determine an identity and an instantaneous location for each of the emitters, thus defining data. The signal processor is configured to communicate the data to a computer.

In another example, a method is performed using an electronic device, the method including sensing an electromagnetic signal emission from each of a plurality of emitters. Each of the signal emissions is characterized by a distinct modulation pattern and a common timeframe. The method also includes determining an identity and a location for each of the emitters. The method further includes communicating data, which includes the identity and the location for each of the emitters, to a computer.

### First Illustrative System

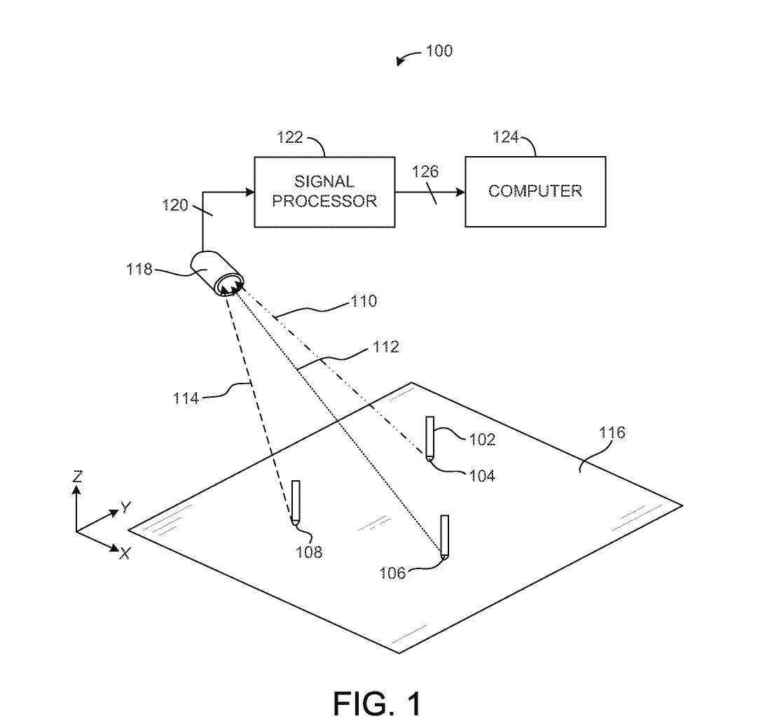

Attention is now turned to FIG. 1, which depicts a system 100 according to the present teachings. The system 100 is illustrative and non-limiting with respect to the present teachings. Other systems, devices, entities or combinations thereof can also be defined and used.

The system 100 includes a stylus 102 including an electromagnetic signal emitter (emitter) 104. In one example, the emitter 104 is defined by, or includes, an infrared light emitter such as a light-emitting diode (LED) or cluster of such LEDs. Other suitable types of signal emitter can also be used. The system 100 also includes other stylus having emitters 106 and 108, respectively.

The emitters 104, 106 and 108 are configured to issue electromagnetic signal within a common spectra, modulated in accordance with a pattern distinct to each particular emitter. Such modulation can be performed by virtue of resources of each particular emitter 104-108, or by way of drive electronics coupled thereto and supported within the associate stylus (e.g., 102). Thus, the emitters 104, 106 and 108 issue electromagnetic signals 110, 112 and 114, respectively, each of which is modulated distinctly within that plurality of emitters.

The system 100 also includes a stylus writing surface (surface) 116. The surface 116 is planar in form and defines an area or region in two-space within which the respective emitters 104-108 can be detected and identified while being moved about a user or respective users. The surface 116 illustrates one non-limiting context and application of the present teachings. The emitters 104-108 can be independently moved about (or displaced) over the surface 116 in a manner emulating handwriting, manual drawing, the selecting of particular areas or regions, or in other suitable ways. Such positioning and movements are detected and individually identified by other aspects of the system 100 described below.

The system 100 also includes a sensor 118. The sensor 118 is configured to detect the signals 110-114 and to provide corresponding electronic signaling 120 to a signal processor 122. The sensor 118 can include any suitable resources or elements such as a light-sensitive detection array, a charge-coupled device (CCD) array, optical lenses or other elements, and so on. In one example, the sensor 118 is defined by or includes an infrared camera. Other suitable sensors can also be used.

The system 100 also includes the signal processor 122 introduced above. The signal processor 122 can include or be defined by any suitable electronic constituency including, but not limited to, an application-specific integrated circuit (ASIC), a processor operating in accordance with a program code, a state machine, digital or analog or hybrid circuitry, and so on. The signal processor 122 is configured to receive the electronic signals 120 from the sensor 118 and to uniquely identify each of the emitters 104-108 and its instantaneous position or location on the surface 116. The signal processor 122 is also configured to derive or construct digital information (i.e., data) including the identity and location of each emitter 104-108. The signal processor 122 can also be configured to ignore or filter ambient electromagnetic signals not originating from the emitters 104-108.

The system 100 further includes a computer 124. The computer 124 can be defined by any suitable general-purpose computer or server configured to operate according to a machine-readable program code. The computer 124 is configured to receive data 126 from the signal processor 122 including location and identity information for the respective emitters 104, 106 and 108. The computer 124 is configured, by virtue of a program code stored on tangible media, to determine respective pathways traversed by the emitters 104-108 by way of the data 126. Each such pathway can be defined, for example, by a locus of the instantaneous locations of that particular emitter over a period of time.

General, normal operation of the system 100 is a follows: a user or users move(s) the emitters 104, 106 and 108 independently about the surface 116. Such motions can emulate writing, drawing, and so on. The emitters 104-108 issue electromagnetic (e.g., infrared) signals 110, 112 and 114, respectively. Each of the signals 110-114 is modulated in accordance with a distinct pattern particular to the corresponding emitter 104-108.

The respective signals 110-114 are detected (or sensed) by the sensor 118 and corresponding electronic signals 120 are provided to the signal processor 122. The signal processor 122 identifies each of the emitters (i.e., stylus) 104-108 by way of the distinct modulation pattern thereof, and determines the two-space location of each on the surface 116. The signal processor 122 can do this, for example, by way of periodic sampling as described hereinafter.

Data 126 including identity and location information for each emitter 104-108 is derived and communicated to the computer 124. Such data 126 can be determined, for example, on a periodic basis such that a stream of discrete identity-and-location data packets or “snapshots” is provided to the computer 124. Other data determination or communication stratagems can also be used.

The computer 124 receives the data 126 and determines or constructs a respective pathway traversed by each of the emitters 104-108. That is, the computer 124 can determine pathways or patterns corresponding to handwriting or print, figures, drawings, area selections, and the like, for each of the emitters 104-108. Such patterns can be presented to a user of the computer 124 by way of an electronic display, recorded on machine-accessible storage media, communicated to a remote entities or entities, processed in accordance with various functions or schemes, and so on. Character or written language recognition, the storing of drawings, or other operations can also be performed.

### Second Illustrative System

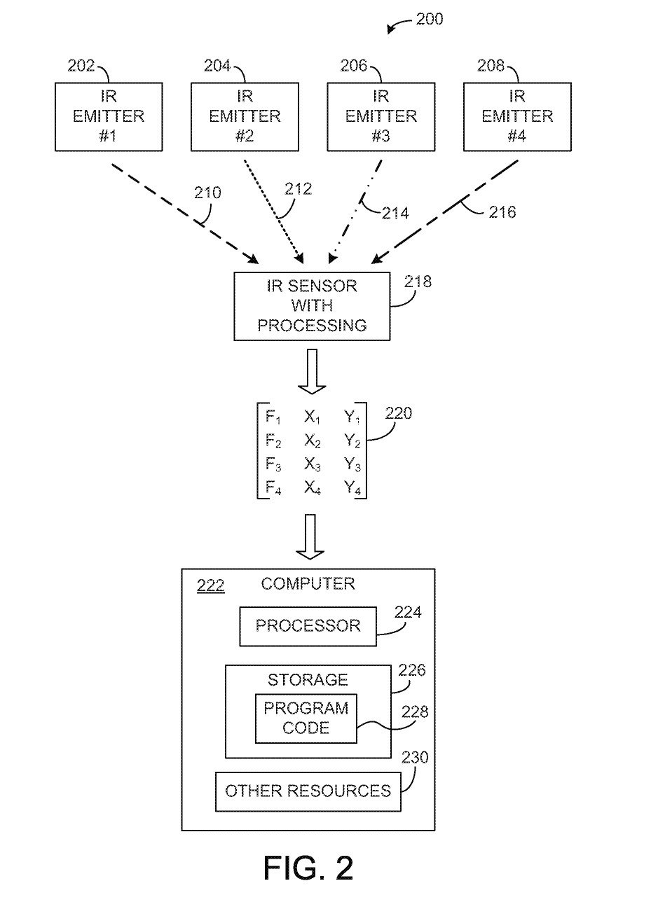

Reference is made now to FIG. 2, which depicts a system 200 according to another example of the present teachings. The system 200 is illustrative and non-limiting in nature. Other systems, devices, entities or combinations thereof can also be defined and used.

The system 200 includes respective infrared (IR) emitters (emitters) 202, 204, 206 and 208, each configured to be independently located or moved about a planar area (two-space). Each of the emitters 202-208 is configured to issue (or broadcast) a light wave signal within the IR region of the electromagnetic spectrum, the signal being amplitude modulated in accordance with a pattern particular to that emitter. The emitters 202-208 thus issue modulated IR signals 210, 212, 214 and 216, respectively. While four emitters 202-208 are depicted in the interest of understanding, the present teachings contemplate other systems having any suitable number of such emitters.

Additionally, the modulation pattern of each emitter 202-208 is characterized by a timeframe common to all of the emitters. In one example, the timeframe is about 15.0 milliseconds. Other suitable timeframes can also be used. Illustrative and non-limiting examples of such modulations patterns are described hereinafter.

The system 200 also includes an IR sensor with signal processing device (device) 218. The device 218 is configured to detect the IR signals 210-216 and to periodically derive a quantitative vector for each signal. Each vector includes data corresponding to one of the emitters 202-208 and the instantaneous location of that emitter in a two-space frame of reference. For example, a particular vector may include an emitter designation “F₁” of “two”, and magnitudes or scalars “four” and “nine” corresponding to respective orthogonal dimensions “X₁” and “Y₁”. Other dimensional schemes can also be used. The four respective vectors are then used to define a matrix 220 encoded in a digital data format. The device 218 is also configured to ignore or filter IR signals or noise issued from various entities other than the emitters 202-208.

The system 200 includes a computer 222. The computer 222 includes a processor 224 configured to perform various normal functions in accordance with a machine-readable program code. The computer 222 also includes a machine-accessible storage media 226 configured to store digital data and information, and so on. The media 226 includes (i.e., stores) a program code 228 accessible to and operable by the processor 224. The computer 222 further includes other resources 230. Non-limiting examples of such other resources include a power supply, an electronic display, a keyboard, a mouse, wireless communications circuitry, network communications circuitry, and so on.

The computer 222 is configured to receive the matrix 220 (as data) from the device 218. Additionally, the computer 222 is configured to receive a plurality of such matrices 220 in successive order, each communicating the instantaneous location of the four respective emitters 202-208. The program code 228 is configured to cause the processor 224 to determine respective pathways traversed by the emitters 202-208 over a period of time. Such pathways can correspond to manual user inputs, the positions or motions of a machine or other entity, and so on. The program code 228 can also cause the processor 224 to record the matrix or matrices 220, process the location vectors in accordance with various functions, and so on.

### Illustrative Modulation Patterns

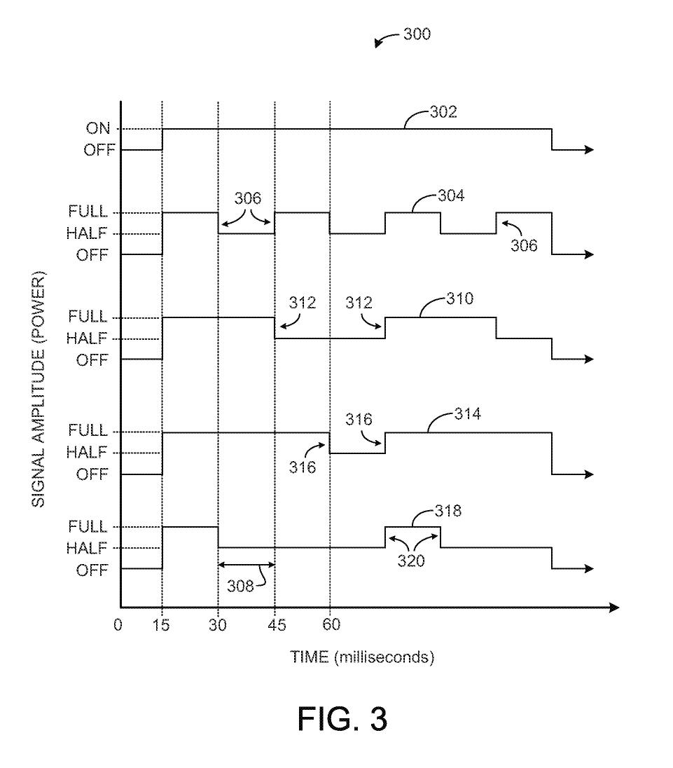

Reference is now made to FIG. 3, which depicts a signal timing diagram (diagram) 300 in accordance with the present teachings. The timing diagram is illustrative and non-limiting with respect to the present teachings. Other signal waveforms or modulation patterns, respectively defined by other characteristics, can also be used.

The diagram 300 includes a status signal plot 302. The status signal 302 corresponds to a status light-emitting diode (LED) as can be present on a stylus (e.g., 102) of the present teaching. The status LED indicates respective “on” or “off” conditions as depicted.

The diagram 300 also includes a modulation pattern 304 corresponding to infrared emissions (e.g., 210) from an emitter (e.g., 202) according to the present teachings. The pattern 304 is characterized by respective step changes 306 in amplitude between a half power output level and a full power output level. Such step changes 306 follow a repeating scheme as depicted. The pattern 304 is also characterized by a timeframe 308. The timeframe 308 is about fifteen milliseconds as depicted. Other suitable amplitude step changes or timeframes can also be used.

The diagram 300 also includes a modulation pattern 310 corresponding to another emitter (e.g., 204). The pattern 310 is characterized by respective step changes 312 in amplitude between a half power output level and a full power output level. Such step changes 312 follow a repeating scheme as depicted. The pattern 310 is also characterized by the timeframe 308.

The diagram 300 also includes a modulation pattern 314 corresponding to another emitter (e.g., 206). The pattern 314 is characterized by respective step changes 316 in amplitude between a half power output level and a full power output level. Such step changes 316 follow a repeating scheme as depicted. The pattern 316 is also characterized by the timeframe 308.

The diagram 300 further includes a modulation pattern 318 corresponding to another emitter (e.g., 208). The pattern 318 is characterized by respective step changes 320 in amplitude between a half power output level and a full power output level. Such step changes 320 follow a repeating scheme as depicted. The pattern 320 is also characterized by the timeframe 308.

The signal timing diagram 300 therefore includes four respective modulation patterns 304, 310, 314 and 318, each characterized by a repeating pattern of step changes in amplitude and a common timeframe. Respective infrared signals modulated in accordance with the patterns 304, 310, 314 and 318 can operate contemporaneously and are individually identifiable by way of signal processing (e.g., 218) of the present teachings.

For example, the present teachings contemplate sampling such infrared (or other electromagnetic) signals at a rate at least twice that of the fifteen millisecond timeframe 308 (e.g., every five milliseconds, seven milliseconds, and so on). Such a sampling frequency assures detection of each step change that occurs. The timing and patterns of such step changes can be compared to modulation patterns being used by the emitters within an association so as to correlate an identity with a location for each of the respective emitters. Other suitable detections and identification stratagems can also be used.

### Illustrative Signal Waveform

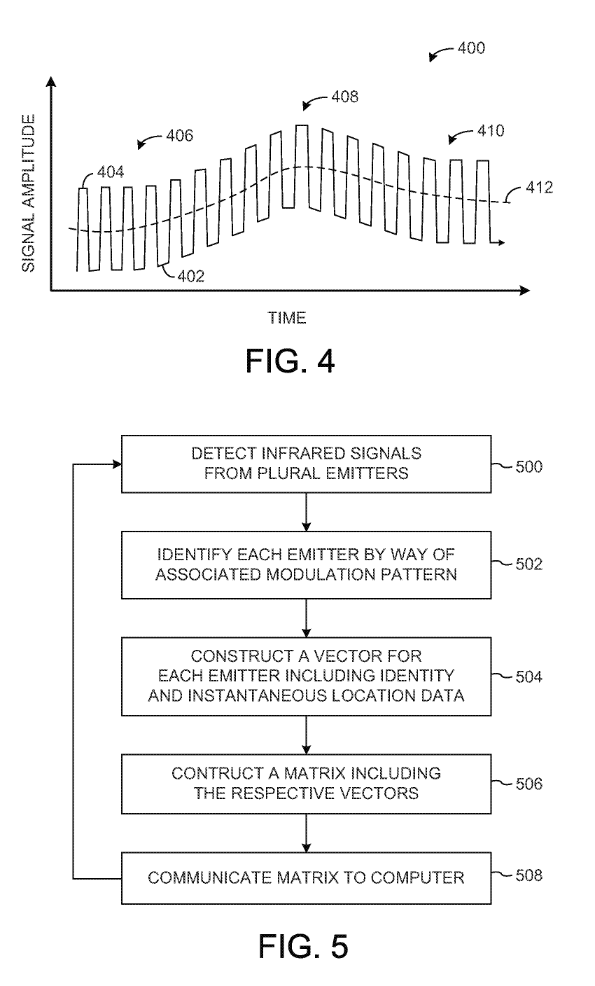

Attention is now directed to FIG. 4, which depicts a signal waveform 400 in accordance with an example operation of the present teachings. The waveform 400 is illustrative and non-limiting in nature, and other waveforms corresponding to other operations are also contemplated. The waveform 400 is illustrative of a modulated IR signal (e.g., 210) issued from an emitter (e.g., 202) in accordance with the present teachings.

The waveform 400 is defined by repeating step changes in amplitude between a minimal power level 402 and a maximum power level 404 thus defining a peak-to-peak swing in power. The waveform 400 is also defined by a first portion 406 during which the source emitter is at a first distance from a sensor (e.g., 218). It is assumed in this example that the source emitter is displaceable toward and away from a corresponding sensor.

The waveform 400 is also defined by a second portion 408 subsequent to the first portion, during which the source emitter is displaced toward the sensor. Thus, the distance from the emitter to the sensor is reduced during the time of the second portion 408.

The waveform 400 is further defined by a third portion 410 subsequent to the second portion, during which the source emitter is displaced away from the sensor. Thus, the distance from the emitter to the sensor is increased during the time of the third portion 410.

An average amplitude (or power level) 412 of the waveform 400 corresponds to the distance from the source emitter to the sensor. That is, the average amplitude 412 is lesser when the emitter is relatively distal to the sensor and is greater when the emitter is relatively proximate to the sensor. Such average power levels and changes can be correlated to distance and used in determining the location of the emitter within a suitable area or frame of reference.

### Illustrative Method

Reference is made now to FIG. 5, which depicts a flow diagram of a method in accordance with the present teachings. The method of FIG. 5 depicts particular steps and an order of execution. However, other methods including other steps, omitting one or more of the depicted steps, or proceeding in other orders of execution can also be defined and used. Thus, the present teachings contemplate other methods that can be respectively varied. Reference is also made to FIGS. 2 and 3 in the interest of understanding the method of FIG. 5.

At 500, respective infrared signals are detected from plural emitters. For purposes of a present example, IR emitters 202-208 issue respective IR signals 210-216. These signals 210-216 are detected by a corresponding sensor 218.

At 502, each emitter is identified by way of an associated modulation pattern. For purposes of the ongoing example, each of the emitters 202-208 is uniquely identified by sampling electronic signals representative of the emissions 210-216 so as to determine the particular pattern of step changes 306, 312, 316 and 320 in amplitude. The respectively determined patterns are then compared (or mapped) against the known modulation patterns 304, 310, 314 and 318 of the emitters 202-208 so as to uniquely identify each emitter within the plurality. The instantaneous location of each identified emitter 202-208 is also determined by way of signal power and location within a known field of view of the sensor.

At 504, a vector is constructed for each emitter including identity and location data. In the present example, a vector is constructed or derived for each emitter 202-208 including identity and location scalars (or values).

At 506, a matrix is constructed including the respective vectors. In the present example, a matrix 220 is constructed or defined that includes the respective vectors derived at step 504 above. Thus, the identity and instantaneous location of all four emitters 202-208 has been quantified and formatted as a matrix, and encoded as digital data.

At 508, the matrix is communicated to a computer. For purposes of the present example, the matrix 220 is communicated to a computer 222 as digital data by way of machine-readable electronic signals. The computer 222 can then perform various operations or functions using the matrix 220 data as illustrated above. A single iteration of the method of FIG. 5 is now complete, and the method returns to step 500 above so as to begin the next iteration, and so on, in a repetitive manner such that a succession or stream of matrices 220 are provided to the computer 222.

in general, the present teachings contemplate systems, apparatus and methods by which a plurality of stylus or other devices can be identified and located within a predetermined area or zone. Each such stylus (or device) includes an electromagnetic energy emitter that issues a signal modulated in accordance with a distinct pattern. A sensor detects each of the emitters, and thus the stylus, within an operable range and provides corresponding electronic signaling to a signal processor.

The signal processor functions to determine an identity and an instantaneous location for each emitter. Signal sampling and pattern matching, or another suitable stratagem, can be used in the identification process. Other sources of electromagnetic energy within the field of view of the sensor are filtered out or otherwise ignored. Data corresponding to the identities and locations of the emitters is derived and formatted as respective vectors, as a matrix of such vectors, or in another suitable way.

The data is communicated to a computer. The computer operates to perform one or more operations by way of the data, such as determining pathways traversed by each emitter, recording the locations or determined pathways, writing or drawing recognition, and so on. The plural emitters and their associated stylus are independently and contemporaneously operable, identifiable and locatable within the field of view (or detection) of one signal sensor.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A system, comprising:
a plurality of emitters each configured to issue an electromagnetic signal characterized by a distinct modulation pattern;
a sensor configured to detect the electromagnetic signals; and
a signal processor coupled to the sensor and configured to determine an identity and an instantaneous location for each of the emitters thus defining data, the signal processor configured to communicate the data to a computer.

2. The system according to claim 1, the emitters configured such that the modulation patterns are characterized by a common timeframe, the signal processor configured to sample each of the detected electromagnetic signals at least twice per timeframe.

3. The system according to claim 1, the emitters configured such that the respective modulation patterns are characterized by step changes in amplitude.

4. The system according to claim 1, each of the emitters configured such that the electromagnetic signal is defined by infrared light.

5. The system according to claim 1, the signal processor configured to identify each of the emitters by way of the respective modulation patterns.

6. The system according to claim 1, the signal processor configured such that the data is formatted as a matrix including an informational vector for each of the emitters.

7. The system according to claim 1 further comprising a computer including a machine-readable media storing a program code, the program code configured to cause the computer to determine a respective pathway traversed by each of the emitters by way of the data.

8. The system according to claim 1, at least one of the emitters configured to be independently displaceable within two-space.

9. The system according to claim 1, at least one of the emitters configured to be manually displaceable by a user.

10. The system according to claim 1, the signal processor configured to determine the identity and the instantaneous location of each emitter and provide the corresponding data to the computer at about regular intervals.

11. The system according to claim 1, the signal processor configured to filter out electromagnetic signals issued by sources other than the emitters.

12. A method performed using an electronic device, comprising:
sensing an electromagnetic signal emission from each of a plurality of emitters, each of the signal emissions characterized by a distinct modulation pattern and a common timeframe;
determining an identity and a location for each of the emitters;
communicating data including the identity and the location for each of the emitters to a computer.

13. The method according to claim 12, the sensing including sensing an infrared light emission from each of the emitters.

14. The method according to claim 12, the determining including ignoring electromagnetic signal emissions from sources other than the emitters.

15. The method according to claim 12 further comprising determining a respective path traveled by each of the emitters by way of the data communicated to the computer.
